(19) United States
(12) Patent Application Publication
(10) Pub. No.: US 2021/0394395 A1
(43) Pub. Date: Dec. 23, 2021

(54) PLOW ASSEMBLY FOR AGGREGATE COOLING IN CONCRETE MANUFACTURING

(71) Applicant: NITROcrete IP, LLC, Fort Collins, CO (US)

(72) Inventors: Eric L. Van Dixhorn, Fort Collins, CO (US); Matthew A. Zion, Johnstown, CO (US); Cameron Wilson, Fort Collins, CO (US); Shawn D. Raffelson, Eaton, CO (US); Christopher Annis, Fort Collins, CO (US)

(21) Appl. No.: 17/351,978

(22) Filed: Jun. 18, 2021

Related U.S. Application Data
(60) Provisional application No. 63/041,628, filed on Jun. 19, 2020.

(51) Int. Cl. B28C 5/46; B28C 7/02; B28C 5/36

(52) U.S. Cl. CPC B28C 5/468; B28C 5/36; B28C 7/02

(57) ABSTRACT

Aspects involve an aggregate plow system that may be used in a system for cooling aggregate, such as may be found in a batch plant involved in producing concrete. The plow system generally contacts aggregate as it is conveyed by a conveyor belt to create a furrow within the aggregate prior to dispensing of liquid nitrogen or other coolant onto the aggregate. Additionally, the plow assembly may mix the ingredients of the aggregate on the belt by disputing the aggregate piled on the conveyor belt. The formation of the furrow, in place of a mound of aggregate on the belt, aids in retaining liquid nitrogen in the furrow such that it may better penetrate into the aggregate and thereby improving cooling. In either and both ways, the plow assembly improves dispersion of the coolant on and into the aggregate as it is conveyed by the conveyor belt.

### CROSS-REFERENCE TO RELATED APPLICATION

This application is related to and claims priority under 35 U.S.C. § 119(e) from U.S. Patent Application No. 63/041,628 filed Jun. 19, 2020 entitled “Aggregate Plow Assembly,” the entire contents of which is incorporated herein by reference for all purposes.

### TECHNICAL FIELD

Aspect of the present disclosure involve cooling aggregate for concrete manufacturing, such as occurs in a concrete batch plant, and more particularly involves a plow device for creating a furrow in the aggregate and/or disturbing aggregate on a conveyor running under the plow assembly for enhancing application of liquid nitrogen on the aggregate.

### BACKGROUND AND INTRODUCTION

Concrete is made from mixing cement with water. Concrete processing also involves mixing aggregate, typically a mixture of sand with gravel or rock, with the cement and water. Mixing cement and water produces heat—it is an exothermic reaction. Proper curing of the concrete can be negatively affected when temperatures exceed various thresholds, and this issue is exacerbated by the exothermic reaction. Thus, techniques have been developed to cool the concrete, or some component of the concrete, so that the concrete is and remains cool enough to cure properly.

Liquid nitrogen has been used to cool the aggregate or the mixture in a mixing truck. For nitrogen to be in a liquid state, its temperature must be at or below −320 F at atmospheric pressure. These extremely low temperatures can be damage many concrete manufacturing components. For example, in a processing plant, conveyors move the aggregate to a mixing truck and the aggregate may be cooled as it is conveyed to the truck. Liquid nitrogen can damage the conveyor components and the conveyor belt itself.

Liquid nitrogen “boils” almost instantly when exposed to warmer temperatures and the transition to gas at that temperature is accompanied by a large volume increase—in some instances 700 times or greater depending on the pressure. The transition and pressure make distribution onto conveyed aggregate very challenging, particularly in a hot outside environment. The pressure accompanying volume increases, for example, tends to blast aggregate off the belt.

In many batch plants, gravel or rock is first distributed onto the belt, followed by sand since the different forms of aggregate are held in different hoppers and are positioned at different locations as the belt moves past. Thus, in some cases, a top layer of sand is deposited over the rock or gravel. In such cases, the sand to some extent deflect liquid nitrogen pouting onto the aggregate and may block some diffusion of the liquid nitrogen to lower layers of the aggregate, inhibiting the most optimal cooling of the aggregate layers. The gas transition also makes penetration into the aggregate, piled on the belt, difficult.

It is with these observations in mind, among others, that aspects of the present disclosure were conceived and developed.

### SUMMARY

One aspect of the present disclosure relates to an apparatus comprising a plow head displacing a portion of an aggregate conveyed by a conveyor system prior to dispensing of a coolant onto the aggregate for mixing with cement. The plow head may further be arranged to be raised and lowered. Generally, the plow is positioned before the liquid nitrogen dispenser, and it is positioned in the path of the belt to engage the aggregate on the belt prior to reaching the liquid nitrogen dispenser. The plow acts to create a furrow and mix the aggregate on the belt. Thus, in the example of sand on top of rock, the plow helps to mix the sand into the rock or gravel and may also create a furrow in the mounded aggregate, thereby making the aggregate more amenable to liquid nitrogen penetration when the mixture reaches the liquid nitrogen head.

Another aspect of the present disclosure relates to a system comprising an aggregate plow device that includes an actuator operably connected to a first end of a pivot arm and a plow head assembly operably connected to a second end of the pivot arm. The system may also include a controller in electrical communication with the actuator to cause rotation of the pivot arm about an axis at the second end of the pivot arm in a first direction, wherein rotation of the pivot arm in the first direction orients a portion of the plow head assembly to displace a portion of an aggregate conveyed by a conveyor system.

Another aspect of the present disclosure relates to an apparatus comprising a plow head displacing a portion of an aggregate conveyed by a conveyor system prior to dispensing of a coolant onto the aggregate for mixing with cement. The apparatus may further comprise a pivot arm operably connected to the plow head and rotatable between a first position and a second position, wherein the plow head engages the aggregate in the first position of the pivot arm and is separate from the aggregate in the second position of the pivot arm and an actuator, such as a pneumatic cylinder, operably connected to the pivot arm to rotate the pivot arm between the first position and the second position. The first position may be based on a signal from a load sensor of the conveyor system, the signal from the load sensor indicating a placement of the aggregate on the conveyor system and/or based on a signal from an aggregate height sensor, the signal from the aggregate height sensor indicating a height of the aggregate on the conveyor system.

In other aspects, the apparatus may include a control system in electrical communication with the actuator, the control system transmitting a control signal to the actuator to activate the actuator, a plurality of upright supports, and/or a cross-bar support connected to and spanning between the plurality of upright supports, wherein the pivot arm is operably connected to the cross-bar support. In some instances, the length of the plurality of upright supports is adjustable. The apparatus may also include a flexible member operably connected to the pivot arm and the plow head, the flexible member providing a resistance in a direction of flow of the aggregate as conveyed by the conveyor system.

Another aspect of the present disclosure relates to a system comprising an aggregate plow device that includes an actuator operably connected to a first end of a pivot arm and a plow head assembly operably connected to a second end of the pivot arm. The system may also include a controller in electrical communication with the actuator to cause rotation of the pivot arm about an axis at the second end of the pivot arm in a first direction, wherein rotation of the pivot arm in the first direction orients a portion of the plow head assembly to displace a portion of an aggregate conveyed by a conveyor system. The plow head assembly may include a flexible member operably connected to the second end of the pivot arm, the flexible member providing a resistance in an opposite direction of flow of the aggregate as conveyed by the conveyor system and a plow head to displace the portion of the aggregate conveyed by the conveyor system.

In some aspects, the displacement of the portion of the aggregate conveyed by the conveyor system occurs prior to dispensing of a coolant onto the aggregate for mixing with cement. Further, the controller may cause rotation of the pivot arm about the axis in a second direction to orient the portion of the plow head assembly to remove the portion of the plow head from the aggregate conveyed by the conveyor system. The rotation of the pivot arm may be in response to a signal from a load sensor associated with the conveyor system, the signal from the load sensor indicating a placement of the aggregate on the conveyor system or in response to a signal from an aggregate height sensor, the signal from the aggregate height sensor indicating a height of the aggregate on the conveyor system. The aggregate plow device may further include a plurality of upright supports and a cross-bar support connected to and spanning between the plurality of upright supports, wherein the pivot arm is operably connected to the cross-bar support, which both may be adjustable when the controller transmits one or more control signals to cause extension or contraction of the plurality of upright supports or the cross-bar support.

These and other aspects of the present disclosure are discussed in more detail in the detailed description section that follows.

### BRIEF DESCRIPTION OF THE FIGURES

The foregoing and other objects, features, and advantages of the present disclosure set forth herein should be apparent from the following description of particular embodiments of those inventive concepts, as illustrated in the accompanying drawings. The drawings depict only typical embodiments of the present disclosure and, therefore, are not to be considered limiting in scope.

FIG. 1 is a first isometric view of an aggregate plow assembly according to one embodiment.

FIG. 2 is a second isometric view of an aggregate plow assembly according to one embodiment.

FIG. 3 is a flowchart of a method for operation of an aggregate plow assembly according to one embodiment.

FIG. 4A is a first representative cross-section view of a conveyor belt conveying aggregate where the aggregate includes a layer of sand on top of a layer of rock, which often occurs in some processing plants, and further illustrating that liquid nitrogen may not thoroughly penetrate the layer of sand and may also be deflected from the layer of sand, and not reach or cool the underlying larger sized rock.

FIG. 4B is a second representative cross-section view of aggregate on a conveyor belt conveying aggregate under a liquid nitrogen dispensing system, the aggregate including a layer of rock on top of a layer of sand, the liquid nitrogen better permeating through the layer of rock to reach the layer of sand.

FIG. 4C is a third representative cross-section view of aggregate on a conveyor belt conveying aggregate under a liquid nitrogen dispensing system, the aggregate including a furrow created in the aggregate through an aggregate plow assembly.

FIG. 5A is a third representative cross-section view of aggregate on a conveyor belt conveying aggregate under a liquid nitrogen dispensing system, the aggregate including a concave cross-sectional shape or furrow that may be defined in the aggregate by a plow, the furrow retaining dispensed liquid nitrogen for better penetration into the aggregate and retaining liquid nitrogen that would otherwise be deflected by the conventional mounding of aggregate on the belt as shown in FIG. 5B thereby providing improved aggregate cooling relative to systems without such a plow.

FIG. 5B is a fourth representative cross-section view of aggregate on a conveyor belt conveying aggregate under a liquid nitrogen dispensing system, the aggregate including a convex or mounded cross-sectional shape that is conventionally present on a conveyor in the absence of a plow creating a furrow, and which deflects nitrogen from the aggregate and does not retain as much nitrogen for penetration into the aggregate.

FIG. 6 is a schematic of a system for dispensing liquid nitrogen onto an aggregate of a concrete batching plant.

### DETAILED DESCRIPTION

Aspects of the present disclosure involve a plow assembly that may be used in a system for cooling aggregate, such as may be found in a batch plant involved in producing concrete. In one example, the plow assembly is positioned over a conveyor belt that conveys aggregate to a mixing truck or otherwise where cement and water are added to the aggregate to produce a concrete mix. The plow assembly generally contacts the aggregate as it is conveyed by the conveyor belt to disrupt the aggregate and create a furrow within the aggregate prior to dispensing of liquid nitrogen or other coolant onto the aggregate. Additionally, the plow assembly may mix the ingredients of the aggregate (such as gravel and sand) on the belt by disturbing the aggregate piled on the conveyor belt. For example, in batching plants where the aggregate is layered with sand on top of another aggregate ingredient (such as gravel), the plow assembly may disrupt the sand layer simultaneously exposing the other aggregate ingredient below the sand layer and mixing the sand layer in with the other ingredient. The plow assembly also may be configured to define or create a furrow in the aggregate passing under the plow on the belt. Mixing of the aggregate ingredients and creating the furrow in the aggregate mound enhances penetration of liquid nitrogen into the aggregate, thereby improving a cooling process. The formation of the furrow, in place of a mound of aggregate on the belt, aids in retaining liquid nitrogen in the furrow such that it may better penetrate into the aggregate and thereby improving cooling. In either and both ways, the plow assembly improves dispersion of the coolant on and into the aggregate as it is conveyed by the conveyor belt.

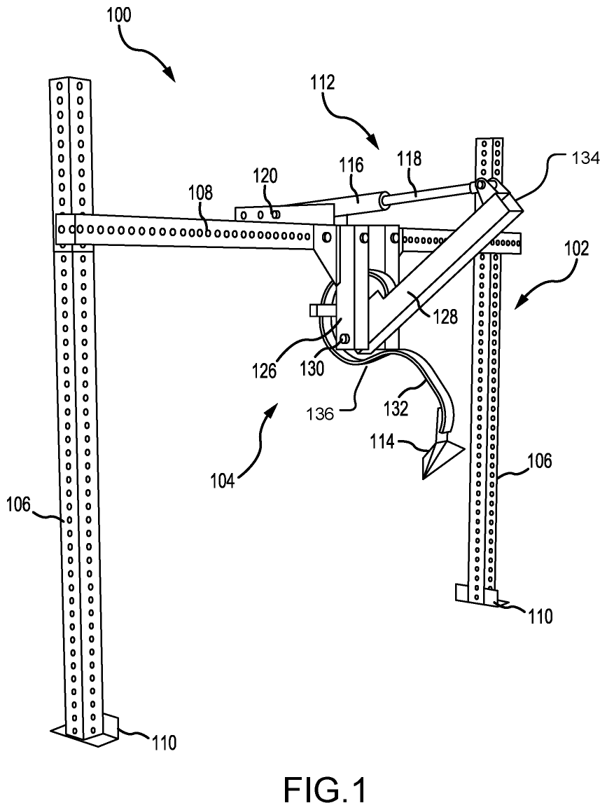

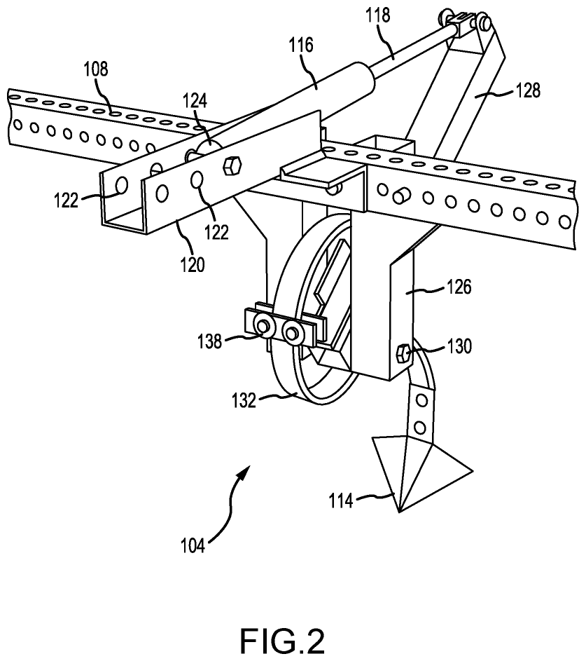

FIGS. 1 and 2 illustrate a plow assembly 100 according to some examples. In one particular implementation, the plow assembly includes a frame 102 to support a plowing assembly 104 positioned over a conveyor belt positioned beneath the plow assembly. The plow assembly 104 is configured to position a plow head 114 to engage and disrupt aggregate as the conveyor belt transports the aggregate. The frame 102 may, in some instances, include a pair of upright or mostly vertical supports 106 and a cross-bar support 108 connected to and spanning between the pair of upright supports. In one example, the upright supports 106 and/or the cross-bar support 106 may be constructed of a durable material, such as a metal alloy. The frame 102 may be mounted on a variety of possible components of a conveyor belt system or other component of a batch plant more generally, depending on the arrangement of the conveyor system and batch plant components. In other instances, the frame 102 may be mounted to a floor or the ground over the conveyor belt and may not necessarily be attached to any component of the batch plant.

The plowing assembly 104 may be mounted on and extend generally downward from the cross-bar support 108. In one example, the plowing assembly 104 may include an actuating control mechanism 112 to control a position of the plow head 114 to create a furrow in the aggregate on the conveyor belt as the aggregate is conveyed under the plowing assembly in one position and to locate the plow head above the aggregate in another position. In one implementation, the actuating control mechanism 112 includes a pneumatic cylinder 116 that extends or retracts a pneumatic arm 118. The actuator mechanism 112 may rotate one or more pivot arms 128 to raise and lower the plow head 114 from a plowing position (in which the plow head is at least partially contacting some of the aggregate carried by the conveyor system) and an unplowing position (in which the plow head is located above and not in contact with the aggregate). The actuator mechanism 112 may also control the penetration depth of the plow head 114 into the aggregate. In some instances, the height of the plow head 114 position relative to the aggregate may be based on a sensor measurement of a height of the aggregate on the conveyor system. Further, different conveyance systems may convey aggregate at various speeds, and various mixtures may have more or less aggregate on the conveyor belt in various proportions of ingredients, such as sand and rock. The plow head depth may, in some implementations, be adjusted by the actuating control mechanism 112 to optimize furrow definition for the various possible alternatives. The adjustment of the plow head 114 may be based on sensor measurements of type of aggregate on the belt, amount of aggregate on the belt, speed of the conveyance system, and the like. Similarly, various plow heads of different sizes and shapes may be used to optimize furrow definition in the aggregate. Nonetheless, lowering the plow head 114 into the aggregate may create a furrow of some shape and may aid in mixing the aggregate on the conveyor belt.

FIG. 1 illustrates a first profile view of the aggregate plow system 100. The plow system 100 is arranged to lower a plow head 114 to engage a mounded aggregate conveyed by a conveyor belt and to raise the plow head to disengage the aggregate. One particularly implementation of a mechanism for adjusting a position of the plow head 114 is shown; however, it is possible to raise and lower the plow head in a variety of other ways including, but not limited to, fixedly mounting the plow system 100 on a platform mounted over the conveyor that raises and lowers such as by one or more pneumatic or telescoping legs or a four bar linkage, by mounting the plow system 100 on a telescoping post above the conveyor and where the post lowers or raises relative to the conveyor, or pivotally mounting a plow head 114 such that it pivots toward or away from the conveyor. In the illustrated implementation, a length of the upright supports 106 and/or the cross-bar support 108 may be adjustable to customize the dimensions of the plow system 100 for mounting or associating with a variety of different possible conveyor systems. For example, the upright supports 106 and/or the cross-bar support 108 may include a telescoping feature that provides for extension or contraction of the upright supports 106 and/or the cross-bar support 108. In other embodiments, the upright supports 106 and/or the cross-bar support 108 may be a fixed length. The adjustability of the upright supports 106 and/or the cross-bar support 108 also allows the plow system 100 to be moved out of the way during instances when it is unnecessary to cool the aggregate carried by the conveyor belt. The adjustability also allows for easy access and replacement of wear components. Further, a corresponding length of the plurality of upright supports 106 and/or the cross-bar support 108 may be adjustable in response to a control signal received from a plow system 100 controller, described in more detail below. In particular, the controller may determine a target height or width of the plow system 100 and provide one or more adjustment signals to the upright supports 106 and/or cross-bar support 108 to adjust to the target height or width. As such, the upright support 106 and/or cross-bar support 108 may include a motorized component or other actuating component to activate in response to a control signal from the controller.

In the implementation illustrated in FIGS. 1 and 2, a mounting bracket 110 may be mounted or otherwise integrated to a lower end of the upright supports 106 for mounting the plow system 100 to a conveyor belt system. The mounting brackets 110 may provide for bolting or welding of the frame 102 onto a top flange of a conveyor belt frame such that the plowing assembly 104 is oriented above the conveyor belt. In general, any mounting assembly may be included on the lower end of the upright supports 106 for mounting of the plow system 100 onto the conveyor system. Further, the cross-bar support 108 may be mounted or otherwise attached to the upright supports 106 such that the cross-bar may span a distance between the upright supports. In some implementations, the cross-bar 108 may attach to each of the upright supports 106 through bolting or welding, although any attachment mechanism may be used to attach the cross-bar to the upright supports. The height at which the cross-bar support 108 attaches to the upright supports 106 may be adjustable such that a plowing assembly 104 that extends downward from the cross-bar is positioned over the conveyor belt of the conveyor system. In one particular implementation, the cross-bar support 108 may be attached to the upright supports 106 such that the plowing assembly 104 penetrates approximately 1-2 inches into the aggregate as conveyed by the conveyor system when the plow system 100 is in a plowing orientation or position, as explained below. In some implementations, the height of the upright supports 106 may be adjusted to locate the plowing assembly 104 over the conveyor belt. In other implementations, the cross-bar support 108 may be mounted or attached to the upright supports 106 at the desired height.

As shown in FIGS. 1 and 2, the plowing assembly 104 may mount to the cross-bar support 108 and may, generally, include an actuating control mechanism 112 and a plow head 114 to create a furrow in the aggregate on the conveyor belt as the aggregate is conveyed under the plowing assembly 104. In the illustrated implementation, the actuating control mechanism 112 includes a pneumatic cylinder 116 and a controllable pneumatic arm 118 that may extend from or retract into the pneumatic cylinder through a typical pneumatic cylinder operation. The pneumatic cylinder 116 may include a mounting end 124 that mounts to a U-shaped or other type of actuating arm bracket 120. The actuating arm bracket 120 may be mounted to and extend perpendicular from the cross-bar support 108. For example, the actuating arm bracket 120 may extend forward of the plow system 100 and support the pneumatic cylinder 116 which may extend rearward of the plow system. In some implementations, the actuating arm bracket 120 may include one or more corresponding mounting holes 122 located through the sides of the U-shaped bracket through which a bolt or other fastener may extend to locate and retain the mounting end of the pneumatic cylinder 116 to the bracket 120. As explained in more detail below, the one or more mounting holes 122 may provide the plowing assembly 104 with a shallower or steeper angle plow head angle. The pneumatic arm 118 may extend from an opposite end of the pneumatic cylinder 116 in response to actuation of the pneumatic cylinder.

The plowing assembly 104 may also include a pivot arm bracket 126 mounted on and extending downward (or toward the conveyor belt assembly) from the cross-bar support 108. A lower end of a pivot arm 128 may be rotatably connected to the pivot arm bracket 126 at a lower end of the bracket. More particularly, a pivot pin 130 may extend through the pivot arm bracket 126 and the lower end of the pivot arm 128 and provide an axle about which the pivot arm may rotate. An upper end 134 of the pivot arm 128 may be operably connected to a distal end of the pneumatic arm 118 to control rotation of the pivot arm 128 about the pivot pin 130. Through this configuration, rotation of the pivot arm 128 about the pivot pin 130 may be controlled by the extension and/or retraction of the pneumatic arm 118. For example, retraction of the pneumatic arm 118 into the pneumatic cylinder 116 may cause the pivot arm 128 to rotate counter-clockwise about the pivot pin. Alternatively, extension of the pneumatic arm 118 into the pneumatic cylinder 116 may cause the pivot arm 128 to rotate clockwise about the pivot pin 130. As explained in more detail below, controlling the pivot arm 128 to rotate about the pivot pin 130 may cause the plow head 114 of the plowing assembly 104, mechanically engaged to a lower end 136 of the pivot arm 128, to contact or be removed from the aggregate transported on the conveyor belt assembly. Further, although described as a pneumatic mechanism, it should be appreciated that the plow system 100 may include any actuating mechanism to rotate the pivot arm 128. For example, a motor driven post that extends or retracts a control arm may be used with the plowing assembly 104 to rotate the pivot arm 128 as described.

A plow head device 114 may be operably connected to the pivot arm 128 by a flexible member 132. In one particular implementation, the flexible member 132 may be S-shaped and generate a forward resistance for the plow head 114 (upstream in relation to a flow of aggregate beneath the plow head) for creating a furrow in the aggregate. More particularly, the S-shape of the flexible member 132 may provide a spring-loaded, forward bias that resists a rearward force on the plow head 114 as the plow head engages the aggregate and the flow of the aggregate pushes the plow head rearwardly, while also providing some flexibility to allow the plow head a rearward movement when a large rearward force is applied to the plow head 114. For example, aggregate transported by the conveyor belt system is not likely to be uniform on the belt, but may include portions of more rock, more sand, or larger portions of each rock and sand. As such, the force required by the plow head 114 to generate a furrow in the aggregate may vary based on the amount and consistency of the aggregate on the belt. For smaller or more easily displaced portions of the aggregate (such as mostly sand aggregate compositions), the force applied by the flexible member 132 to maintain the plow head 114 in the aggregate to create a furrow in the aggregate may be less than the force applied by the flexible member for larger or denser portions of the aggregate. When encountering a dense portion (such as mostly gravel aggregate compositions), the plow head 114 may be rearwardly and upwardly displaced (due to forward pressure applied to the plow head from the aggregate being furrowed and the S-shape of the flexible member. However, the S-shaped member 132 may resist this rearward movement of the plow head 114 and provide a spring-loaded forward force to the plow head to maintain the plow head's contact with the aggregate and create the furrow. In this manner, the S-shaped member 132 allows for the plow head 114 to displace aggregate in different types and densities of aggregate conveyed by the conveyor belt assembly while acting as a shock absorber as the aggregate of different densities passes around the plow head.

In one implementation, the plow head 114 may be triangular with flared sides to displace aggregate as the aggregate flows past the plow head 114. Other types of plow heads 114 may be attached to the flexible member 132 for alternate displacement of the aggregate. Further, in some implementations and as shown in FIG. 2, a catch plate 138 may be mounted on the flexible member 132. The catch plate 138 may prevent the plow head 114 from contacting the conveyor belt should the flexible member 132 become detached from the pivot arm 128. In such circumstances, the catch plate 138 may hold the flexible member 132 in place above the conveyor belt upon detachment from the pivot arm 128, although the forward bias of the flexible member may be lessened In some implementations, the catch plate 138 may be adjustably located on flexible member 132 to prevent contact of the plow head 114 with different types of conveyor belt assemblies.

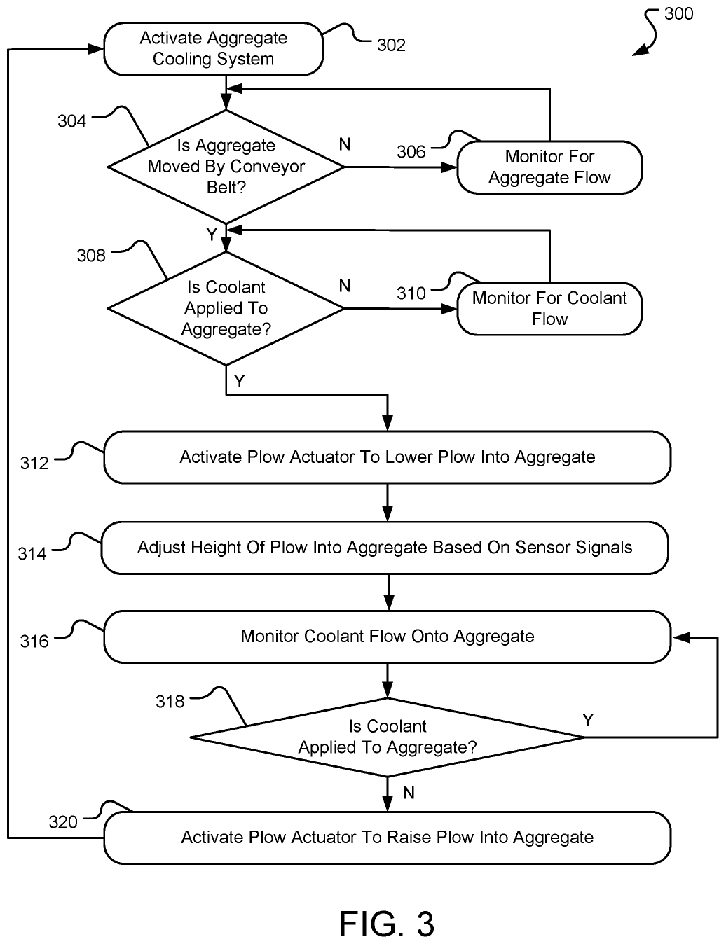

FIG. 3 is a flowchart of a method 300 for operation of an aggregate plow system according to one embodiment. The method 300 of FIG. 3 may be used to operate the aggregate plow system 100 described above with relation to FIGS. 1 and 2. However, the aggregate plow system 100 described above is but one example of an aggregate plow that may be used for cooling aggregate at a batch plant. Other designs, components, and systems may be utilized to create a furrow in aggregate for application of coolant to the aggregate. Thus, although described herein in relation to the embodiments of FIGS. 1 and 2, the method 300 of FIG. 3 may be used with other implementations of an aggregate plow assembly or system. The method 300 further may apply to an aggregate plow system mounted or otherwise associated with a conveyor belt system on which aggregate is transported. Control of the aggregate plow system may be integrated in the batch plant control system or controller of an aggregate cooling system such that operation of the plow system may occur in cooperation with operation of the coolant system and/or batch plant.

Beginning in operation 302, an aggregate cooling system may be activated to begin applying a coolant onto aggregate being transported on a conveyor belt. In one implementation, the coolant may be liquid nitrogen, although other cooling substances may be used. At operation 304, a control system may determine if aggregate is transported on the conveyor belt and, if not, may continue to monitor the presence of aggregate on the conveyor belt in operation 306. For example, a load sensor may be oriented in relation to the conveyor belt to detect a weight of aggregate on the conveyor belt. If the load sensor detects a weight on the belt above a threshold value, the aggregate cooling system may assume that aggregate is being moved by the belt. One or more optical sensors may also be used to detect the presence of aggregate on the conveyor belt. In another example, a controller of a concrete batch plant may send a signal to the aggregate cooling system or other control device upon release of aggregate onto the conveyor belt. As long as aggregate is not carried on the belt as determined by the sensor, the aggregate cooling system may continue to monitor for the presence of the aggregate. However, if aggregate is detected on the conveyor belt, the control system may determine, in operation 308, if the coolant of the cooling system is flowing onto the aggregate. For example, some environmental conditions do not require a cooling of the aggregate such that the cooling system may not be activated during these conditions. However, if the aggregate is to be cooled, the aggregate cooling system may determine that coolant is being applied to the aggregate. Otherwise, if coolant is not flowing, the control system may continue to monitor for coolant flow in operation 310. In one example, the detection of the flow of coolant onto the aggregate may be a signal received from a batch plant controller.

Upon detection of coolant application to the aggregate, the control system may activate the plow actuator 112 to lower the plowing assembly into the aggregate in operation 312. In one embodiment and in relation to the implementations described above, the actuator 112 may be activated to extend a control arm 118 to rotate a pivot arm 128 and lower a plow head 114 into the aggregate. Other embodiments may lower the plow head 114 into the aggregated based on a retraction of the control arm. Regardless of the actuating mechanism used, the plow head 114 may be lowered into the aggregate as the aggregate is moved by the conveyor belt to displace at least a portion of the aggregate for a more efficient cooling of the aggregate. In this manner, the aggregate plowing system 100 may be located upstream from the coolant dispenser such that the coolant is applied within the furrow created by the plow head 114.

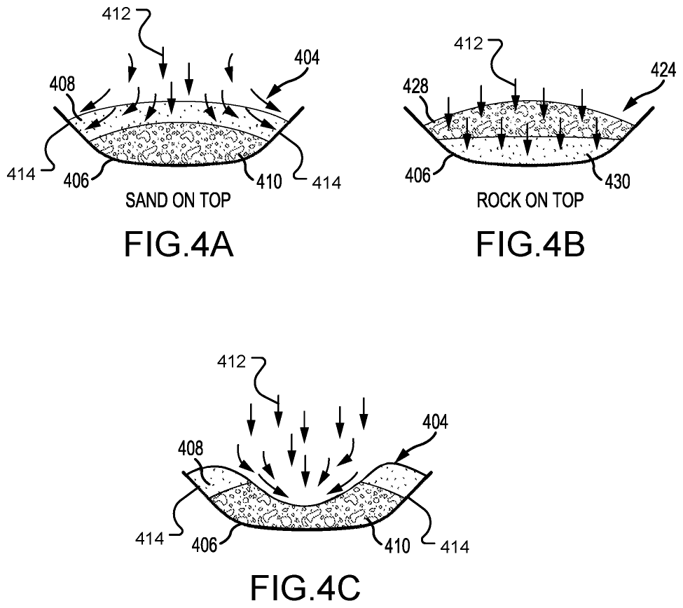

Plowing of the aggregate provides at least two benefits over non-plowing of the aggregate. One such benefit is illustrated in FIGS. 4A and 4B. FIGS. 4A and 4B illustrate a representative cross-section view of aggregate 404 on a conveyor belt 406 conveying the aggregate under a coolant dispensing system. In FIG. 4A, the aggregate 404 comprises a top layer 408 comprising sand and a bottom layer 410 comprising rock or other larger circumference materials on the conveyor belt 406. This orientation of the layers of the aggregate 404 may occur when the sand bin of the batch plant is located downstream of the rock bin such that the rock 410 is loaded onto the conveyor belt 406 before the sand 408. However, when a coolant 412 is applied to the top sand layer 408 from a coolant dispensing system, the sand may prevent adequate penetration of the coolant down into the rock layer 410. As such, the rock layer 410 may not be cooled by the applied coolant, resulting in suboptimal cooling of the entirety of the aggregate. In contrast, a more adequate penetration of the coolant to the bottom layer of the aggregate 404 may occur when the layers of the aggregate are reversed, as shown in FIG. 4B. In this example, the aggregate 424 includes a top rock layer 428 and a bottom sand layer 430 on the conveyor belt 406. As the top rock layer 428 allows the liquid coolant 412 to permeate to the bottom sand layer 430, dispersal of the coolant is more efficient in the orientation of FIG. 4B.

The aggregate plow system 100 described herein may aid in improving the efficiency of the dispersal of the coolant throughout the aggregate, particularly in circumstances illustrated in FIG. 4A in which the top layer 408 of the aggregate 404 is sand. In particular, as shown in FIG. 4C, the plow head 114 may disperse the top sand layer 408 towards the sides 414 of the conveyor 406 and expose at least a portion of the bottom rock layer 410 through the creation of a furrow in the aggregate 404. By exposing the bottom rock layer 410 to the applied coolant, both the top sand layer 408 and the bottom rock layer 410 may be cooled by the coolant 412 application.

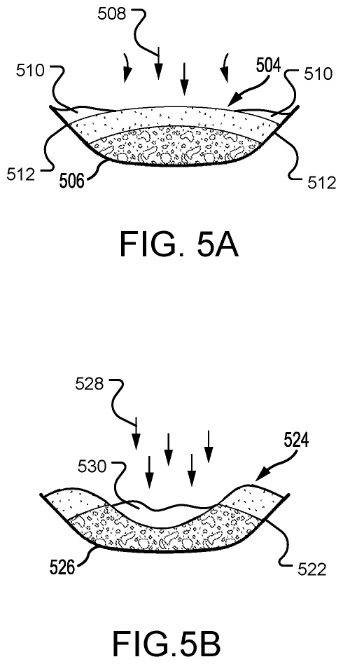

Another benefit of the use of the aggregate plow system is illustrated in FIGS. 5A and 5B. FIG. 5A illustrates a cross-section of a potential aggregate pile 504 on a conveyor system 506 in which the cross-section of the aggregate has a convex shape. When coolant 508 is applied to aggregate 504 with that shape, the coolant may strike the top layer of the aggregate and flow down the sides of the aggregate to pool 510 against the sides 512 of the conveyor belt, resulting in uneven dispersal of the coolant onto the aggregate. A more efficient dispersal may be obtained from application of the coolant 506 onto aggregate 504 with a cross-sectional concave shape, as shown in FIG. 5B. In this instance, the coolant 528 may pool 530 in the center of the aggregate 524, thereby keeping the coolant on the aggregate for a longer period of time for cooling. The aggregate plow system 100 described herein may create such a concave shape in the aggregate on the conveyor belt to aid in improving the efficiency of the dispersal of the coolant 528 throughout the aggregate. More particularly, the aggregate plow system 100 may create a trough or valley near the center of the aggregate 524 to form the desired concave shape in the aggregate. In this manner, the trough formed by the plowing apparatus may further improve the cooling of the aggregate 504.

Returning to the method 300 of FIG. 3 and in some instances, the height of the plow head 114 position relative to the aggregate may be adjusted in operation 314 based on a sensor measurement of a height of the aggregate on the conveyor system. For example, the plow apparatus may include a visual or optical sensor that determines a height of the aggregate on the conveyor belt. In response to a determined height, the position of the plow head 114 relative to the surface of the aggregate may be adjusted such that the plow head maintains contact with the aggregate. For a lower amount of aggregate on the conveyor belt, the position of the plow head 114 may be lowered and for higher amounts of aggregate, the position of the plow head 114 may be raised. Further, different conveyance systems may convey aggregate at various speeds and the location of the plow head 114 may be adjusted accordingly. The plow head depth may, in some implementations, be adjusted by the actuating control mechanism 112 to optimize furrow definition for the various possible alternatives. The adjustment of the plow head 114 may be based on sensor measurements of type of aggregate on the belt, amount of aggregate on the belt, speed of the conveyance system, and the like.

The aggregate control system may, in operation 316, monitor the flow of coolant onto the aggregate, after plowing, and determine in operation 318, if the coolant is flowing onto the plowed aggregate. If yes, the system may continue to monitor to ensure the application of coolant onto the aggregate. If the coolant flow is detected as stopped, however, the control system may actuate the plow assembly to raise the plow head out of the aggregate carried by the conveyor system and return to operation 302 for reactivation of the aggregate cooling system. In this manner, the control system may control plowing of the aggregate based on the monitored flow of aggregate and/or coolant. In other implementations, the plow assembly may be operated manually or controlled by an operator monitoring the batch plant operations. Regardless of the control system used, the plow system 100 may create a furrow or trough in the aggregate on the conveyor belt to provide the cooling benefits outlined above.

Returning to the embodiment of the aggregate plow system 100 of FIGS. 1 and 2, configuration of the dimensions of the plow system may be set or selected during installation of the system for proper plowing of the aggregate. For example, the mounting of the cross-bar support 108 may be located at a selected height on the upright supports 106 or the upright supports may be adjustable. In another example, the pivot arm bracket 126 may be mounted at any point along the cross-bar support 108 to center or otherwise locate the plow assembly 104 over the conveyor belt system. Also, as mentioned above, the actuating arm bracket 120 may include one or more corresponding mounting holes 122 providing the plowing assembly 104 with a shallower or steeper angle plow head angle. In general, a more forward mounting of the pneumatic cylinder 116 on the bracket 120 provides a steeper angle for the plow head 114 and a more rearward mounting of the cylinder on the bracket provides a shallower angle of the plow head. In still another example, various plow heads 114 may be used with the system 100 for different plowing techniques.

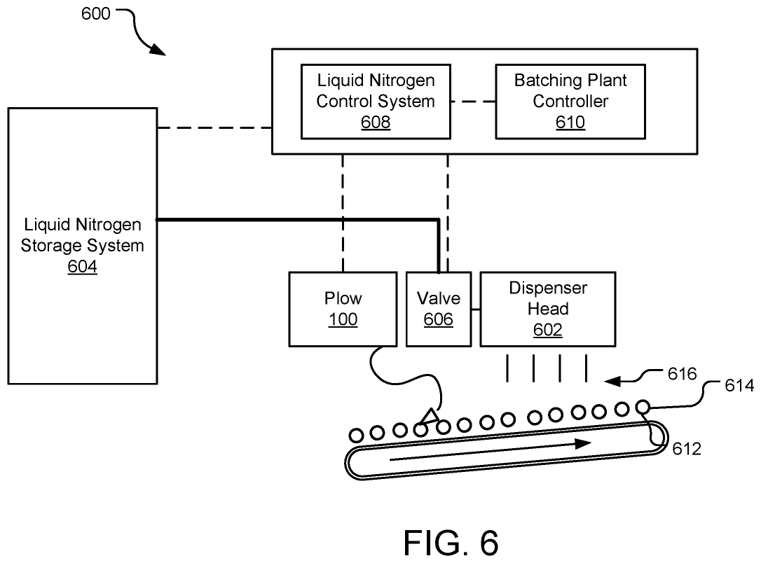

FIG. 6 is a schematic of a cooling system 600 for dispensing liquid nitrogen 616 onto an aggregate 614 of a concrete batching plant that includes at least some portion of the aggregate plow apparatus discussed above. In one implementation, the system 600 may include the plow assembly 100 as discussed above with relation to FIGS. 1-5B. While shown as a discrete component of the batch plant, the plow also be coupled with the cooling head or coupled with other components of the batch plant. The components of the cooling system 600 may be part of a concrete batching plant at which ingredients for concrete may be mixed or otherwise provided. As discussed above, cooling of an aggregate included in a concrete mix may aid in proper curing of the concrete such that a coolant, such as liquid nitrogen, may be dispensed onto the aggregate at the concrete batching plant. It should be appreciated that additional or fewer components may be included in the system 600 but are not discussed herein for brevity.

The cooling system 600 may include a dispenser head 602 for dispensing a coolant, such as liquid nitrogen 616, onto an aggregate 614 carried beneath the dispensing head by a conveyance system 612. Liquid nitrogen may be provided to the intake port of the dispenser head 602 from a liquid nitrogen storage system 604. The liquid nitrogen storage system 604 stores a supply of liquid nitrogen, which may be conveyed via a piping system to valve 606 and dispenser head 602. The valve 606 may control the output flow of liquid nitrogen to the dispenser head 602. When the valve 606 is opened, a flow of liquid nitrogen can be output from the valve to the dispenser head 602. As discussed above, an aggregate plow assembly 104 may be included with the cooling system 600 to create a furrow in the aggregate 614 transported on the conveyance system 612.

The aggregate plow assembly 104 may be adjustable through an actuation system to generate deeper or shallower furrows in the aggregate based on one or more control signals. For example, some components of the system 600 may be controlled automatic-ally, such as through computerized control system 608. The control system 608 may be, in some instances, communicatively coupled with a liquid nitrogen storage system 604, valve 606, a computer implemented batching plant controller 610, and/or any other component of the system 600. Not all communicative couplings are required, however. Similarly, various operations may be combined into a discrete controller. By communicatively coupling the liquid nitrogen control system 608 to liquid nitrogen storage system 604 and/or valve 606, the liquid nitrogen control system can control dispensing of liquid nitrogen to the dispenser head 602. This allows the liquid nitrogen control system 608 to control when and for how long a portion of the liquid nitrogen is conveyed to the dispensing head 602 and dispensed onto the aggregate 614, i.e., initiation and cessation. The liquid nitrogen control system 608 can also control the position of the aggregate plow assembly 104 relative to the aggregate 614 on the conveyance system 612, in some instances in response to a signal from one or more sensors. In other examples, the position of the aggregate plow assembly 104 may be controlled through one or more control signals provided by the liquid nitrogen control system 608 and/or the batching plant controller 610. By coupling the liquid nitrogen control system 608 with the batching plant controller 610, the batching plant controller can send an input signal to the liquid nitrogen control system to indicate when to initiate and cease dispensing liquid nitrogen; how much liquid nitrogen to dispense; and how cold the liquid nitrogen should be, for example. In addition, the batching plant controller 610 may control a height position of the aggregate plow assembly 104 relative to the conveyance system 612 and/or the aggregate 614 present on the conveyance system.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

What is claimed is:

1. An apparatus for a concrete facility, the apparatus comprising:
a conveyor carrying aggregate
a dispensing head positioned over the conveyor to dispense coolant onto the aggregate as the aggregate is carried by the conveyor; and
a plow positioned to engage the aggregate conveyed by the conveyor prior to dispensing of the coolant onto the aggregate.

2. The apparatus of claim 1 further comprising a pivot arm operably connected to the plow and rotatable between a first position and a second position, wherein the plow engages the aggregate in the first position of the pivot arm and is separate from the aggregate in the second position of the pivot arm.

3. The apparatus of claim 2 further comprising an actuator operably connected to the pivot arm to rotate the pivot arm between the first position and the second position.

4. The apparatus of claim 3, wherein the actuator is a pneumatic cylinder.

5. The apparatus of claim 3 further comprising:
a control system in electrical communication with the actuator, the control system transmitting a control signal to the actuator to activate the actuator.

6. The apparatus of claim 2 further comprising:
a plurality of upright supports; and
a cross-bar support connected to and spanning between the plurality of upright supports, wherein the pivot arm is operably connected to the cross-bar support.

7. The apparatus of claim 6, wherein a length of the plurality of upright supports is adjustable.

8. The apparatus of claim 2 further comprising:
a flexible member operably connected to the pivot arm and the plow, the flexible member providing a resistance in a direction of flow of the aggregate as conveyed by the conveyor system.

9. The apparatus of claim 2, wherein the first position is based on a signal from a load sensor of the conveyor, the signal from the load sensor indicating a placement of the aggregate on the conveyor.

10. The apparatus of claim 2, wherein the first position is based on a signal from an aggregate height sensor, the signal from the aggregate height sensor indicating a height of the aggregate on the conveyor.

11. A system comprising:
an aggregate plow device comprising:
an actuator operably connected to a first portion of a pivot arm; and
a plow head assembly operably connected to a second portion of the pivot arm;
and
a controller in electrical communication with the actuator to cause rotation of the pivot arm about an axis at the second end of the pivot arm in a first direction, wherein rotation of the pivot arm in the first direction orients a portion of the plow head assembly to displace a portion of an aggregate conveyed by a conveyor system.

12. The system of claim 11, wherein the plow head assembly comprises:
a flexible member operably connected to the second end of the pivot arm, the flexible member providing a resistance in an opposite direction of flow of the aggregate as conveyed by the conveyor system; and
a plow head to displace the portion of the aggregate conveyed by the conveyor system.

13. The system of claim 11, wherein the displacement of the portion of the aggregate conveyed by the conveyor system occurs prior to dispensing of a coolant onto the aggregate for mixing with cement.

14. The system of claim 11, wherein the controller causes rotation of the pivot arm about the axis in a second direction to orient the portion of the plow head assembly to remove the portion of the plow head from the aggregate conveyed by the conveyor system.

15. The system of claim 11, wherein the actuator is a controllable pneumatic cylinder.

16. The system of claim 11, wherein the controller causes the rotation of the pivot arm in response to a signal from a load sensor associated with the conveyor system, the signal from the load sensor indicating a placement of the aggregate on the conveyor system.

17. The system of claim 11, wherein the controller causes the rotation of the pivot arm in response to a signal from an aggregate height sensor, the signal from the aggregate height sensor indicating a height of the aggregate on the conveyor system.

18. The system of claim 11, wherein the aggregate plow device further comprises: a plurality of upright supports; and a cross-bar support connected to and spanning between the plurality of upright supports, wherein the pivot arm is operably connected to the cross-bar support.

19. The system of claim 18, wherein a length of the plurality of upright supports or the cross-bar support is adjustable.

20. The system of claim 19, wherein the controller transmits one or more control signals to cause extension or contraction of the plurality of upright supports or the cross-bar support.
